(19) United States
(12) Patent Application Publication
(10) Pub. No.: US 2004/0155062 A1
(43) Pub. Date: Aug. 12, 2004

(54) Bottle system useful for storing and mixing materials

(76) Inventors: Kathy McCurry, Dallas, TX (US); Saber Thaxton, Dallas, TX (US)

Correspondence Address: VINSON & ELKINS L.L.P., 1001 FANNIN STREET, 2300 FIRST CITY TOWER, HOUSTON, TX, 77002-6760, US

(21) Appl. No.: 10/773,358

(22) Filed: Feb. 6, 2004

Related U.S. Application Data
(60) Provisional application No. 60/446,382, filed on Feb. 10, 2003.

(51) Int. Cl. B67D 5/60

(52) U.S. Cl. 222/145.5

(57) ABSTRACT

A bottle system includes a plurality of squeezable interior bottles, a sleeve, and a mixing nozzle. The squeezable interior bottles are operable for separately storing a plurality of materials. The interior bottles each include at least one outlet for dispensing the materials when the bottle system is squeezed by hand. The sleeve is operable for being engaged with the interior bottles. The interior bottles are held in proximity to each other when engaged with the sleeve. The mixing nozzle is coupled to the bottle system proximate the outlets. The mixing nozzle receives the materials stored in the interior bottles and combines the materials to produce a mixture when the bottled system is squeezed by hand. A method includes distributing a bottle system that includes a plurality of squeezable interior bottles, a sleeve, and a mixing nozzle. The squeezable interior bottles are operable for separately storing a plurality of materials. The interior bottles each include at least one outlet for dispensing the materials when the bottle system is squeezed by hand. The sleeve is operable for being engaged with the interior bottles. The interior bottles are held in proximity to each other when engaged with the sleeve. The mixing nozzle is coupled to the bottle system proximate the outlets. The mixing nozzle receives the materials stored in the interior bottles and combines the materials to produce a mixture when the bottled system is squeezed by hand.

This application claims the benefit of U.S. Provisional Application No. 60/446,382 filed Feb. 10, 2003.

### BACKGROUND OF THE INVENTION

1. Field of the Invention

This invention relates generally to a bottle system, and, more particularly, to a bottle system useful for separately storing materials therein and for mixing the materials when the bottle is squeezed by hand and the materials are dispensed from the bottle.

2. Description of the Related Art

Bottles have conventionally been used to package and distribute a variety of different materials. Generally, a bottle serves to hold and preserve its contents, for at least some period of time, until the material is ready to be used or consumed. Materials suitable for distribution in bottle type packaging include, for example, food products, health care products, household products, first aid products, and countless other products.

Squeezable bottles have proven to be a useful and convenient mechanism for holding and dispensing a number of different materials. Squeezable bottles are generally made of plastic or other types of compressible materials that are suitable for use with the squeeze-action of the bottle. These types of bottles provide the preservation and storage capacity of regular bottles but also provide an easy mechanism for dispensing the product from the bottle. For example, when compressed, the force exerted on the bottle causes the evacuation of its contents through an outlet, usually located at the top of the bottle. This functionality has proven useful in a number of different applications.

In one application, condiments, such as ketchup, mayonnaise, and the like are packaged and distributed in a squeezable bottle. For example, ketchup may be packaged in a squeezable bottle, which serves to hold the ketchup until the consumer is ready to use the product. To dispense the ketchup from inside the bottle, the consumer aims the bottle at a desired destination and squeezes the bottle. The ketchup is then forced through an outlet and directed to the desired destination. A similar approach is used for countless other products, such as sunscreen, bath gel, dishwashing soap, hand lotions, hair gel, medicine, etc.

For certain tasks or undertakings, it is advantageous to use multiple (i.e., two or more) materials (e.g., products) at or near the same time to achieve the desired results. These materials are often combined during use to produce the expected result. For example, hair coloring generally requires the application of the processor and dye pigment at or near the same time. Likewise, a number of different medicinal treatments require the application of multiple remedial products at or near the same time. One example is the treatment of poison ivy, which generally includes the application of both aloe vera gel and anti-itch ointment on the infected area.

For other tasks or undertakings, it is simply a matter of preference to combine certain materials. There are a number of combinational preferences of different materials that are commonly accepted. For example, certain food products are generally combined before they are consumed. Ketchup and mustard are often both applied to sandwiches and other food items. Likewise, yogurt is often combined with fruit puree prior to consumption. Other examples, include the combination of sun block and lotions (i.e., one to protect from the sun and the other to moisturize), stain removers and laundry detergents, carpet cleaner and deodorizer, etc.

Even though certain materials may be combined in use, they are traditionally packaged in separate bottles, distributed individually, and purchased by the end-user independently. One reason for this may be that some materials cannot be combined prior to use, thus these materials are not susceptible to pre-mix and packaging. This separate packaging and distribution approach may raise the cost of the materials due to, for example, increased shipping and marketing costs. These extra costs are often passed on to the end-user. In addition to added costs, consumers and other end-users are forced to store and deal with numerous bottles, even when the materials are intended to be used for the same application.

For some materials, such as epoxy, one solution has been to combine the materials into one container. The container is generally configured so that the individual components making up the epoxy are stored separately and then mixed as they are dispensed from the container. This has the advantage of saving the end-user from purchasing the epoxy components separately and then having to store and keep up with the individual bottles. In addition, the container is often designed so that a certain ratio is maintained as the materials are dispensed from the container. Unfortunately, these approaches are typically implemented with mechanical assistance devices, such as plungers, air compression, and the like, to aid in dispensing the materials from the container. These devices are often complicated to fabricate and use and generally add to the packaging costs of the materials.

The present invention is directed to overcoming, or at least reducing the effects of, one or more of the problems set forth above.

### SUMMARY OF THE INVENTION

In one aspect of the invention, a bottle system is provided. The bottle system includes a plurality of squeezable interior bottles, a sleeve, and a mixing nozzle. The squeezable interior bottles are operable for separately storing a plurality of materials. The interior bottles each include at least one outlet for dispensing the materials when the bottle system is squeezed by hand. The sleeve is operable for being engaged with the interior bottles. The interior bottles are held in proximity to each other when engaged with the sleeve. The mixing nozzle is coupled to the bottle system proximate the outlets. The mixing nozzle receives the materials stored in the interior bottles and combines the materials to produce a mixture when the bottled system is squeezed by hand.

In another aspect of the present invention, a method is provided. The method includes distributing a bottle system that includes a plurality of squeezable interior bottles, a sleeve, and a mixing nozzle. The squeezable interior bottles are operable for separately storing a plurality of materials. The interior bottles each include at least one outlet for dispensing the materials when the bottle system is squeezed by hand. The sleeve is operable for being engaged with the interior bottles. The interior bottles are held in proximity to each other when engaged with the sleeve. The mixing nozzle is coupled to the bottle system proximate the outlets. The mixing nozzle receives the materials stored in the interior bottles and combines the materials to produce a mixture when the bottled system is squeezed by hand.

### BRIEF DESCRIPTION OF THE DRAWINGS

The invention may be best understood by reference to the following description taken in conjunction with the accompanying drawings, in which like reference numerals identify like elements, and in which:

FIG. 1 is a side-view of an illustrative bottle system in accordance with one embodiment of the present invention;

FIG. 2 is a front-view of the illustrative bottle system of FIG. 1;

FIG. 3 is a bottom-view of the illustrative bottle system of FIG. 1;

FIG. 4 is a top-view of illustrative interior bottles used with the bottle system of FIG. 1;

FIG. 5 is a top-view of the illustrative bottle system of FIG. 1; and

FIG. 6 is an assembled view of the illustrative bottle system of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

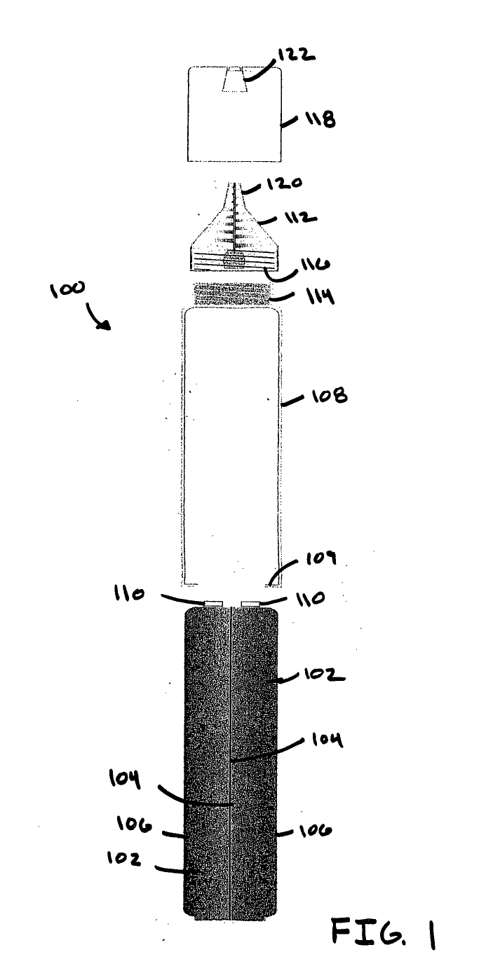

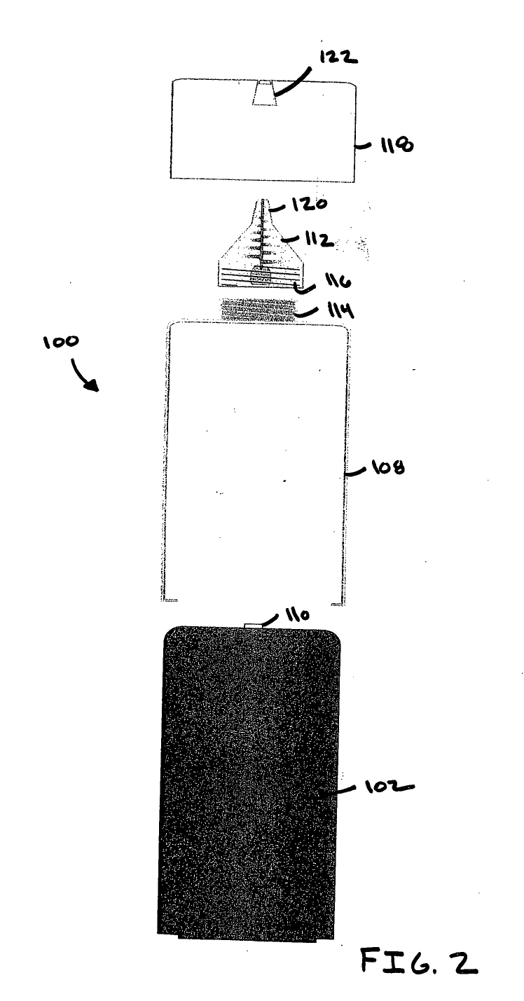

Referring to FIGS. 1 and 2, a bottle system 100 in accordance with one embodiment of the present invention is shown. The bottle system 100 may be used to separately store and mix any number of different materials. In one illustrative embodiment, the materials are separately stored in interior bottles 102. Although only two interior bottles 102 are shown in the illustrative example, it should be appreciated that any number of interior bottles 102 may be used with the bottle system 100.

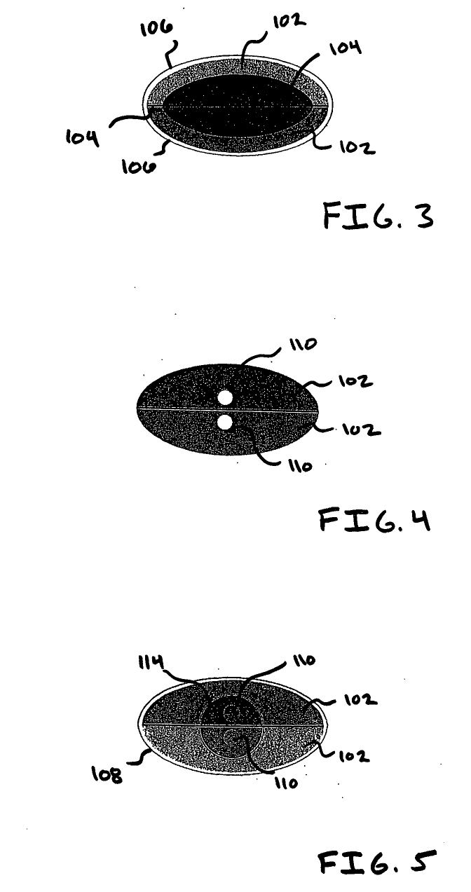

The interior bottles 102 may be configured to any particular shape. Referring to FIG. 3, a bottom-view of the bottle system 100 is shown. In this illustrative embodiment, the interior bottles 102 are shown with a flat inner edge 104 and a curved outer edge 106. The flat inner edges 104 of the interior bottles 102 may be positioned together when assembling the bottle system 100. This configuration of the interior bottles 102 not only simplifies assembly but also produces an overall appearance that end-users are accustomed to.

Even with alternative configurations (e.g., square, round, rectangular, serpentine, etc.), during assembly, the interior bottles 102 may be placed in proximity to each other. When positioned as such, the interior bottles 102 may be held together using a variety of different techniques. Referring back to FIGS. 1 and 2, in this example, the interior bottles 102 are held together with a sleeve 108. The sleeve 108 may be configured to be slideably engaged with the interior bottles 102. When engaged, the interior bottles 102 are held together. In one illustrative embodiment, the dimensions of the sleeve 108 and the interior bottles 102 may be configured so that friction and tension force hold the sleeve 108 in contact with the interior bottles 102. In addition, the sleeve 108 may include a lip 109 along at least some portion of one end to assist in holding the interior bottles 102 inside the sleeve 108. Adhesive may also be placed between the sleeve 108 and interior bottles 102 if desired.

In another illustrative embodiment, the sleeve may be comprised of a band or other type of device placed around the interior bottles 102. For example, the sleeve may be formed from shrink-wrapping the interior bottles with plastic. Alternatively, the sleeve may be formed from a transparent film, such as a fluorinated polymer, that is applied using vacuum lamination. The transparent film may be sintered to the interior bottles 102. Regardless of the materials or methods employed, when the bottle system 100 is assembled, the sleeve serves to hold the interior bottles 102 in proximity to each other.

In another embodiment, the interior bottles 102 may be formed as part of one bottle. For example, the interior bottles 102 may be formed by partitioning a bottle (not shown) of desired size with a divider (not shown). In an injection molding process, for example, this could be done by adding the divider to the bottle form. Other techniques or manufacturing processes could be used as well. Furthermore, it should be appreciated that a bottle having any number of interior bottles 102 may be produced using these techniques. Moreover, under this approach, use of the sleeve 108 may not be necessary.

The interior bottles 102 and the sleeve 108 may be comprised of a number of different materials. Generally, the interior bottles 102 and the sleeve 108 are comprised of a flexible plastic like material that is capable of tolerating the squeeze-action used for dispensing the materials stored therein. Although any number of different materials may be used, in one illustrative embodiment, the interior bottles 102 and the sleeve 108 may be comprised of clear low density polyethylene.

The interior bottles 102 include outlets 110 for dispensing the materials stored therein. The outlets 110 are also shown in FIG. 4, which illustrates a top-view of the interior bottles 102. Although the outlets 110 are illustrated as being circular in this example, it should be appreciated that the outlets 110 may be configured in any number of different shapes and dimensions. For example, the outlets 110 may be oval, beveled, grooved, etc.

The outlets 110 may serve as a pathway for materials to be added to and/or dispensed from the interior bottles 102. For example, during the packaging process, the outlets 110 may be used to add the desired materials to the interior bottles 102. Alternatively, different outlets (not shown) or methods may be used to add the materials to the interior bottles 102. During use, however, when the bottle system 100 is squeezed by hand, the materials are dispensed out from the interior bottles 102 through the outlets 110.

Referring back to FIGS. 1 and 2, a mixing nozzle 112 for combining the materials stored in the interior bottles 102 is shown. It should be appreciated that a number of different techniques may be used to make the mixing nozzle 112 operable with the bottle system 100. In the illustrative example shown, the sleeve 108 includes a male threaded fitting 114 that is adapted for mating with corresponding female threads 116 of the mixing nozzle 112. In this way, the mixing nozzle 112 may be removably attached to the sleeve 108. When aligned, the threads 114 and 116 may be engaged via rotation, and the mixing nozzle 112 may be securely attached to the sleeve 108. In an alternative embodiment, the mixing nozzle 112 may be fixedly attached to the sleeve 108 or other portions of the bottle system 100 using adhesive, crimping, or any other suitable technique.

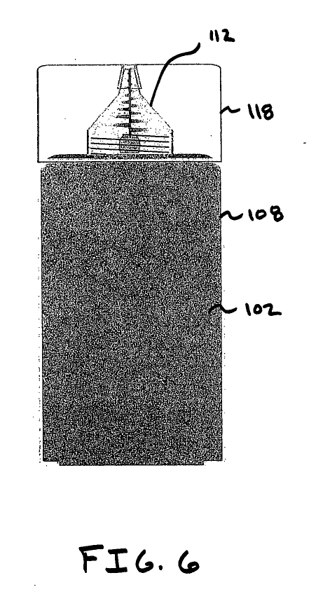

The mixing nozzle 112 is operable to combine the materials stored in the interior bottles 102. Referring to FIG. 5, a top-view of the sleeve 108 with the interior bottles 102 engaged therewith is shown. The mixing nozzle 112 has been removed for the purpose of illustration. As shown, the locations of the outlets 110 are configured to be proximate to an opening in the sleeve 108, when the two are engaged. In this example, the locations of the outlets 110 have been configured to correspond with the opening in the sleeve 108 formed by the male fitting 114. When the outlets 110 are positioned as such, the materials stored in the interior bottles 102 may be dispensed through the mixing nozzle 112 when the bottle system 100 is squeezed by hand. For example, when the bottle system 100 is squeezed by hand, the interior bottles 102 are compressed, and the materials are forced out the outlets 110 through the mixing nozzle 112. This action causes the materials to be combined.

In one particular application, the mixing nozzle 112 is operable to produce a homogeneous mixture when the bottle system 100 is squeezed by hand. In this example, the mixing nozzle 112 may receive the contents from the interior bottles 102 and mix the contents in a manner sufficient to produce such a result. To assist the mixing process, each interior bottle 102 may be configured with multiple outlets 110 (e.g., two or more.) The additional outlets 110 are generally operable to pre-mix the contents of the interior bottles 102 while the materials are being received by the mixing nozzle 112, which ordinarily produces a better-mixed output.

The size, dimensions, and other features of the mixing nozzle 112 may be configured to increase or decrease the flow of mixed materials exiting the bottle system 100. These features may be based on, for example, the viscosity of the materials being mixed. Generally, if the materials include a high viscosity, the flow pathways (e.g., the outlets 110 and the mixing nozzle 112) may be increased to compensate. Likewise, if the materials include a low viscosity, the flow pathways may be decreased to compensate.

The bottle system 100 may also be configured to combine the materials stored in the interior bottles 102 at a desired ratio. In one embodiment, the size of the outlets 110 may be configured to produce the desired mix ratio. For example, if a two-to-one ratio is desired, one outlet 110 may be made twice the size of the other outlet 110. Likewise, the mixing nozzle 112 may be configured to receive and combine the materials at the desired ratio. For example, the mixing efficiency of the mixing nozzle 112 may be increased/decreased by increasing/decreasing the number of spirals (i.e., revolutions) the materials make inside the mixing nozzle 112. In addition, the pitch (i.e., angle) of the mixing nozzle 112 may be adjusted to produce a desired result. Furthermore, the addition of baffles, deflectors, and like devices may be implemented inside the mixing nozzle 112 to induce turbulence in the mixing process. It should be appreciated that these methods may be customized to a particular application to produce a desired mix ratio.

Referring back to FIGS. 1 and 2, a cap 118 may be placed over the mixing nozzle 112, when the bottle system 100 is not in use. In this illustrative example, the cap 118 may be friction-fit over an end 120 of the mixing nozzle 112 using recess 122. It should be appreciated that other methods for attaching the cap 118 to the bottle system 100 may be used as well. In FIG. 6, the illustrative bottle system 100 is shown assembled (i.e., the interior bottles 102 are engaged with the sleeve 108 and the mixing nozzle 112 is attached thereto) with the cap 118 fixed to the mixing nozzle 112.

The bottle system 100 may be used in a variety of different applications that include the use of different materials. As described above, the interior bottles 102 are operable for separately storing materials prior to their use. This is advantageous because some materials cannot be combined prior to use. In other instances, there may be marketing, manufacturing, distributing, and other types of advantages gained from separately storing materials prior to their use. With food products, for example, it is often more appealing to have the materials appear separate on the grocery shelf, even though they are to be combined when consumed. The combination of ketchup and mustard, for instance, generally appears more appetizing if stored separately. The same may be true for mustard and relish. Other food related example combinations include peanut butter and jelly, squeezable butter with cinnamon, and the like.

The bottle system 100 may also be used with a number of different cosmetic and beauty aid products. In one application, one interior bottle 102 may be filled with glycolic exfoliating scrub, while the other interior bottle 102 is filed with a cleanser. In another application, one interior bottle 102 may be filled with cleansing oil, while the other interior bottle 102 is filled with herbal cleansing extract.

The bottle system 100 may also be used in the automotive industry. In one application, for example, one interior bottle 102 may be filed with a degreaser, while the other interior bottle 102 is filled with a general hand cleaner. In another application, one interior bottle 102 may be filled with grease, while the other interior bottle 102 is filled with a synthetic lubricant. In this example, the bottle system 100 may be used to simultaneously apply both lubricating materials to automotive parts during assembly. In short, the bottle system 100 may be filled with any number of different materials and used in a wide array of different applications.

In addition, the sleeve 108 and/or the interior bottles 102 may be labeled with various colors, designs, marketing, and advertising materials. In one application, the interior bottles 102 may be filled with materials from two independent suppliers. For example, one interior bottle 102 may be filled with mustard from a first supplier, while the other interior bottle 102 is filled with relish from a second supplier. To identify the suppliers, the sleeve 108 may be marked on one side with the label of the first supplier, while the other side of the sleeve 108 may be marked with the label of the second supplier. During packaging, the bottle system 100 may be assembled so that the identifying marks on the sleeve 108 appear next to the corresponding interior bottle 102. In another embodiment, the interior bottles 102 may be marked with the label of the supplier of the material. During packaging, a clear sleeve 108 may be used to assemble the bottle system 100. The clear sleeve 108 allows the labeling and other identifying material on the interior bottles 102 to be read.

The bottle system 100 may be marketed and distributed through a number off different channels that will likely vary depending upon the particular application or end-use. For example, with food products, the bottle system 100 may be distributed through grocery types stores, supermarkets, convenience stores, and the like. With automotive applications, the bottle system 100 may be distributed, for example, through retail and automotive stores.

When the end-user acquires the bottle system 100, the materials are separately stored in the interior bottles 102. The materials may be held in this state until ready to be used for a particular application. To apply the materials, the end-user squeezes the bottle system 100 by hand to dispense the materials stored in the interior bottles 102. The squeezing action compresses the sleeve 108, which in turn, compresses the interior bottles 102. The compression force causes the materials to flow through the outlets 110 and into the mixing nozzle 112. The mixing nozzle 112 receives the materials and produces a mixture that is dispensed from the bottle system 100 at a rate that is determined by the hand squeezing force being applied.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A bottle system, comprising:
a plurality of squeezable interior bottles operable for separately storing a plurality of materials, wherein each interior bottle includes at least one outlet for dispensing the materials when the bottle system is squeezed by hand;
a sleeve operable for being engaged with the interior bottles, wherein the interior bottles are held in proximity to each other when engaged with the sleeve;
a mixing nozzle, wherein the mixing nozzle is coupled to the bottle system proximate the outlets, and the mixing nozzle is operable to receive the materials stored in the interior bottles and combine the materials to produce a mixture when the bottle system is squeezed by hand.

2. The bottle system of claim 1, wherein the sleeve is adapted to be slideably engaged with the interior bottles, and the sleeve includes an opening that is positioned proximate to the outlets when engaged with the interior bottles.

3. The bottle system of claim 2, wherein the sleeve includes a lip along at least a portion of one end to assist in holding the interior bottles inside the sleeve.

4. The bottle system of claim 2, wherein the mixing nozzle is coupled to the opening of the sleeve.

5. The bottle system of claim 4, wherein the mixing nozzle includes female threads for removably mating with a male threaded fitting of the sleeve.

6. The bottle system of claim 1, wherein the bottle system includes two interior bottles.

7. The bottle system of claim 6, wherein each interior bottle includes at least one flat surface, and the flat surfaces are positioned adjacent to each other when the interior bottles are engaged with the sleeve.

8. The bottle system of claim 1, wherein the interior bottles are comprised of clear low density polyethylene.

9. The bottle system of claim 1, wherein the bottle system is adapted to combine the materials at a predetermined ratio.

10. The bottle system of claim 1, wherein the sleeve includes marketing material disposed thereon.

11. The bottle system of claim 1, wherein the mixture is a homogeneous mixture.

12. The bottle system of claim 1, further comprising a cap for covering the mixing nozzle when the bottle system is not in use, wherein the cap includes a recess that is adapted to be friction fit with an end portion of the mixing nozzle.

13. A method, comprising:
distributing a bottle system, wherein the bottle system includes:
a plurality of squeezable interior bottles operable for separately storing a plurality of materials, wherein each interior bottle includes at least one outlet for dispensing the materials when the bottle system is squeezed by hand;
a sleeve operable for being engaged with the interior bottles, wherein the interior bottles are held in proximity to each other when engaged with the sleeve;
a mixing nozzle, wherein the mixing nozzle is coupled to the bottle system proximate the outlets, and the mixing nozzle is operable to receive the materials stored in the interior bottles and combines the materials to produce a mixture when the bottle system is squeezed by hand.

14. The method of claim 13, wherein the sleeve is adapted to be slideably engaged with the interior bottles, and the sleeve includes an opening that is positioned proximate to the outlets when engaged with the interior bottles.

15. The method of claim 14, wherein the sleeve includes a lip along at least a portion of one end to assist in holding the interior bottles inside the sleeve.

16. The method of claim 14, wherein the mixing nozzle is coupled to the opening of the sleeve.

17. The method of claim 16, wherein the mixing nozzle includes female threads for removably mating with a male threaded fitting of the sleeve.

18. The method of claim 13, wherein the bottle system includes two interior bottles.

19. The method of claim 18, wherein each interior bottle includes at least one flat surface, and the flat surfaces are positioned adjacent to each other when the interior bottles are engaged with the sleeve.

20. The method of claim 13, wherein the interior bottles are comprised of clear low density polyethylene.

21. The method of claim 13, wherein the bottle system is adapted to combine the materials at a predetermined ratio.

22. The method of claim 13, wherein the sleeve includes marketing material disposed thereon.

23. The method of claim 13, wherein the mixture is a homogeneous mixture.

24. The method of claim 13, wherein the bottle system includes a cap for covering the mixing nozzle when the bottle system is not in use, wherein the cap includes a recess that is adapted to be friction fit with an end portion of the mixing nozzle.
